(19) United States
(12) Patent Application Publication
(10) Pub. No.: US 2007/0234855 A1
(43) Pub. Date: Oct. 11, 2007

(54) SCREWDRIVER WITH MULTI-SECTIONED HANDLE

(76) Inventor: Bobby Hu, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/419,011

(22) Filed: May 18, 2006

(30) Foreign Application Priority Data
Apr. 11, 2006 (TW) 95112883

(51) Int. Cl. B25B 13/46

(52) U.S. Cl. 81/60; 81/63.1

(57) ABSTRACT

A selective one-way screwdriver includes a handle including a grip, a driving device for driving a bit-coupling member in a selected one of two opposite directions, a first driving section, a second driving section comprising a skid-proof device and a third driving section comprising a skid-proof device. The diameter of the first driving section is larger than that of the second driving section. The diameter of the second driving section is larger than that of the third driving section. The first, second and third driving sections are good for providing different maximum torques at different top speeds.

### BACKGROUND OF INVENTION

1. Field of Invention

The present invention relates to a screwdriver and, more particularly, to a screwdriver with a multi-sectioned handle.

2. Related Prior Art

A typical screwdriver includes a single-sectioned handle such as the handle 4 disclosed in U.S. Pat. No. 6,047,802. Such a singled-driving sectional handle is made with a large diameter good for providing a large maximum torque for a user. Such a large diameter is useful during the beginning of a slackening operation and the ending of a tightening operation; it is however not useful in the other phases of the operations.

The present invention is therefore intended to obviate or at least alleviate the problems encountered in prior art.

### SUMMARY OF INVENTION

According to the present invention, a selective one-way screwdriver includes a handle including a grip, a driving device for driving a bit-coupling member in a selected one of two opposite directions, a first driving section, a second driving section comprising a skid-proof device and a third driving section comprising a skid-proof device. The diameter of the first driving section is larger than that of the second driving section. The diameter of the second driving section is larger than that of the third driving section. The first, second and third driving sections are good for providing different maximum torques at different top speeds.

The primary advantage of the handle of the present invention is the provision of the various modes that are preferred in various phases of a slackening or tightening operation.

Other advantages and features of the present invention will become apparent from the following description referring to the drawings.

### BRIEF DESCRIPTION OF DRAWINGS

The present invention will be described through detailed illustration of three embodiments referring to the drawings.

FIG. 1 is a perspective view of a handle of a screwdriver according to the first embodiment of the present invention.

FIG. 2 is another perspective view of the screwdriver shown in FIG. 1 during rotation.

FIG. 3 is a perspective view of a shank engaged with the handle of the screwdriver shown in FIG. 1.

FIG. 4 is a perspective view of a handle of a screwdriver according to the second embodiment of the present invention.

FIG. 5 is a perspective view of a handle of a screwdriver according to the third embodiment of the present invention.

### DETAILED DESCRIPTION OF EMBODIMENTS

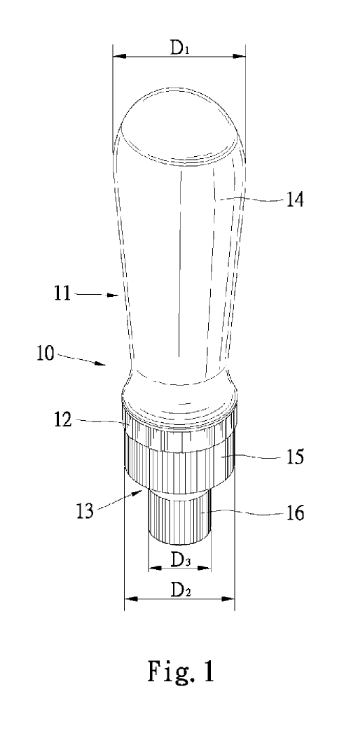

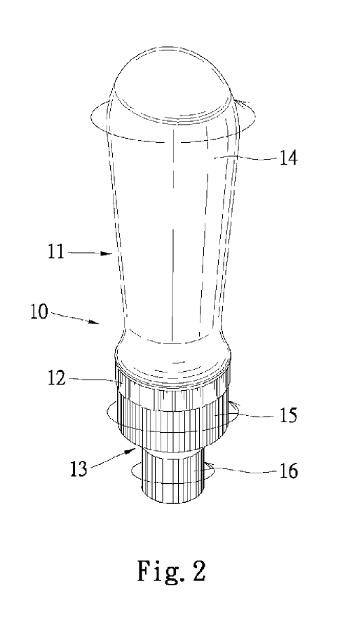

Shown in FIGS. 1 to 3 is a handle 10 of a selective one-way screwdriver according to a first embodiment of the present invention. The handle 10 includes a grip 11, a driving device 13 for driving a bit-coupling member or shank 20 in a selected one of two opposite directions and a switch 12 operable for selecting from the opposite directions.

Preferably, the grip 11 is formed with a first driving section 14. The driving device 13 is formed with a second driving section 15 and a third driving section 16.

The first driving section 14 is made with a first diameter D1. The second driving section 15 is made with a second diameter D2. The third driving section 16 is made with a third diameter D3. The first diameter D1 is larger than the second diameter D2 that is larger than the third diameter D3.

The first driving section 14 is good for providing a large maximum torque at a low top speed. Generally, such a large maximum torque is needed at the beginning of a slackening operation and the ending of a tightening operation.

The second driving section 15 is good for providing a moderate maximum torque at a moderate top speed. Such a moderate maximum torque is used during most of a slackening or tightening operation.

The third driving section 16 is good for providing a small maximum torque at a high top speed. Such a high speed is preferred at the beginning of a tightening operation or the ending of a slackening operation.

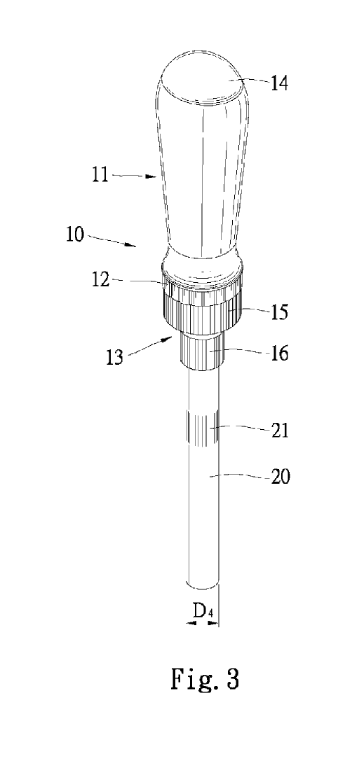

Referring to FIG. 3, the shank 20 includes a driving section 21 made with a fourth diameter D4 smaller than the third diameter D3. Hence, the driving section 21 of the shank 20 is good for providing a smaller maximum torque and a higher top speed than the third driving section 16 of the handle 10.

The driving sections 15 and 16 of the handle 10 and the driving section 21 of the shank 20 are formed with a skid-proof pattern for providing sufficient friction between itself and a user's fingers. The skid-proof pattern includes a plurality of parallel lines.

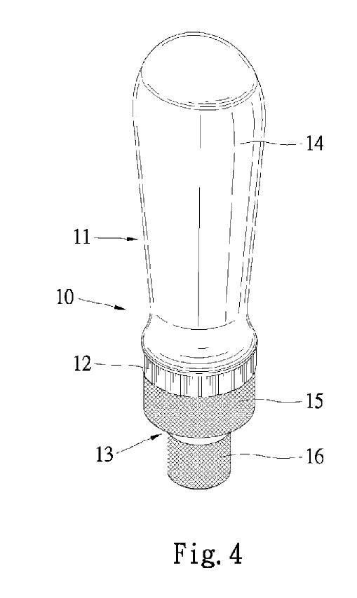

Shown in FIG. 4 is a handle 10 of a screwdriver according to a second embodiment of the present invention. The second embodiment is like the first embodiment except including a different skid-proof pattern. In the second embodiment, the skid-proof pattern is a net.

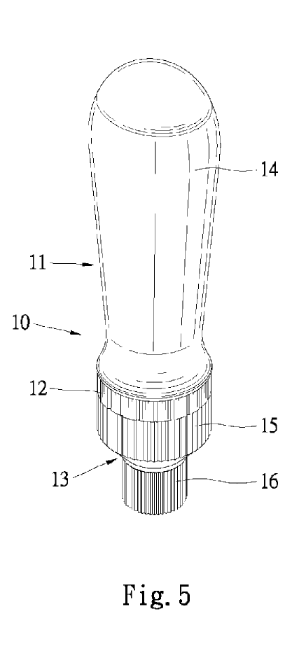

Shown in FIG. 5 is a handle 10 of a screwdriver according to a third embodiment of the present invention. The third embodiment is like the first embodiment except including ridges instead of the skid-proof pattern. The ridges include a triangular cross-driving sectional profile.

Advantageously, the handle of the present invention provides users with various modes that are preferred in various phases of a slackening or tightening operation.

The present invention has been described through the illustration of the embodiments. Those skilled in the art can derive variations from the embodiments without departing from the scope of the present invention. Therefore, the embodiments shall not limit the scope of the present invention defined in the claims.

What is claimed is:

1. A selective one-way screwdriver comprising a handle comprising a grip, a driving device for driving a bit-coupling member in a selected one of two opposite directions, a first driving section formed on said grip, a second driving section formed on said driving device and with a skid-proof device and a third driving section formed on said driving device and with a skid-proof device, wherein said first driving section comprises a first diameter, and said second driving section comprises a second diameter smaller than said first diameter, and said third driving section comprises a third diameter smaller than said second diameter so that said first, second and third driving sections are adapted for providing different maximum torques at different top speeds.

2. A selective one-way screwdriver according to claim 1 comprising a switch operable for selecting from said opposite directions.

3. A selective one-way screwdriver according to claim 1 wherein said skid-proof device of each of said second and third driving sections comprises a pattern.

4. A selective one-way screwdriver according to claim 3 wherein said pattern comprises a plurality of parallel lines.

5. A selective one-way screwdriver according to claim 3 wherein said pattern comprises a net.

6. A selective one-way screwdriver according to claim 1 wherein said skid-proof device of each of said second and third driving sections comprises a plurality of parallel ridges.

7. A selective one-way screwdriver according to claim 1 comprising a shank for connection to said driving device.

8. A selective one-way screwdriver according to claim 7 wherein said shank comprises a fourth driving section formed thereon.

9. A selective one-way screwdriver according to claim 8 wherein said fourth driving section is made with a fourth diameter smaller than said first, second and third diameters.

10. A selective one-way screwdriver according to claim 8 wherein said fourth driving section comprises a skid-proof device.

11. A selective one-way screwdriver according to claim 10 wherein said skid-proof device of each of said second and third driving sections comprises a pattern.

12. A selective one-way screwdriver according to claim 11 wherein said pattern comprises a plurality of parallel lines.

13. A selective one-way screwdriver according to claim 11 wherein said pattern comprises a net.

14. A selective one-way screwdriver according to claim 10 wherein said skid-proof device of each of said second and third driving sections comprises a plurality of parallel ridges.
